(19) United States
(12) Patent Application Publication
(10) Pub. No.: US 2010/0313497 A1
(43) Pub. Date: Dec. 16, 2010

(54) Wind Turbine Tower, A Wind Turbine And A Method For Assembling A Wind Turbine Tower

(76) Inventor: Jesper Kofoed Jensen, Aalborg (DK)

Correspondence Address: ST. ONGE STEWARD JOHNSTON & REENS, LLC, 986 BEDFORD STREET, STAMFORD, CT, 06905-5619, US

(21) Appl. No.: 12/194,188

(22) Filed: Aug. 19, 2008

Related U.S. Application Data
(63) Continuation of application No. PCT/DK2006/000101, filed on Feb. 20, 2006.

(51) Int. Cl. F03D 11/04; E04H 12/00; E04B 1/19

(52) U.S. Cl. 52/173.1; 52/651.07; 52/655.1; 52/745.17

(57) ABSTRACT

The invention relates to a wind turbine tower comprising at least two adjacent metal tower plates. The wind turbine tower is characterized in that, the tower plates are connected by one or more fish joints. The invention further relates to a wind turbine and a method for assembling a wind turbine tower.

### CROSS-REFERENCE TO RELATED APPLICATIONS

The present application is a continuation of pending International patent application PCT/DK2006/000101, filed Feb. 20, 2006, which designates the United States, the content of which is incorporated herein by reference.

### FIELD OF THE INVENTION

The invention relates to a wind turbine tower comprising at least two adjacent metal tower plates, a wind turbine and a method for assembling a wind turbine tower.

### BACKGROUND OF THE INVENTION

A wind turbine known in the art comprises a tapered wind turbine tower and a wind turbine nacelle positioned on top of the tower. A wind turbine rotor with a number of wind turbine blades is connected to the nacelle through a low speed shaft, which extends out of the nacelle front as illustrated on FIG. 1.

Wind turbine towers typically comprise a number of tapered round tower sections mounted on top of each other. The tower sections are usually bolted together through internally placed horizontal flanges, which are welded to the top and bottom of each tower section. Each tower sections comprise a number of tower rings welded to each other. These tower rings are usually made of steel plates, which are rolled into a circular shape and welded to make them constitute a closed 360° ring.

The general idea behind this design is that, the tower has to be relatively easy to assemble at the mounting site and that a round tower without any visible joints is more pleasing to the eye. But in recent years the development of mass-produced wind turbines has moved towards making them bigger and bigger, both in output and in size. This process calls for better and more cost-efficient components and manufacturing methods, and particularly in the field of wind turbine towers, this development has been profound. The manufacturing facilities for large modern wind turbine towers as described above demands a building with a free height of 8 m, access to lifting equipment with a capacity of 70 t and highly specialised and expensive rolling equipment. Furthermore, welding reduces the towers fatigue limit and thereby its strength, which makes it necessary to make the tower or at least parts of the tower of plates thicker than what otherwise, would be necessary.

Furthermore, the size of welded towers has almost—or in some cases already—reached the limit of what can be transported on most roads, in that the diameter of the tower is limited to what can pass under bridges, through tunnels etc.

One way of dealing with these problems is disclosed in European patent application EP 1 561 883. This application discloses a wind turbine tower made of staggered prefabricated metal parts. The metal parts are formed as long substantially rectangular plates, which are open at the side facing the inside of the tower. The parts are bolted together on the inside of the tower through their adjacent sides. Large annular stiffening ring can be provided to the inside of the tower to improve the towers rigidity. This design provides for a polygonal tower where welding are severely reduced or eliminated. But the metal parts have a complex design and are thereby difficult and expensive to manufacture.

An object of the invention is to provide for a wind turbine tower without the mentioned disadvantages.

Especially it is an object of the invention to provide for a cost efficient tower design which provides for a simple tower manufacturing process.

### SUMMARY OF THE INVENTION

The invention provides for a wind turbine tower comprising at least two adjacent metal tower plates. The wind turbine tower is characterized in that, the tower plates are connected by one or more fish joints.

It is advantageous to make the tower by connecting tower plates by means of fish joints, in that it enables a simple tower design where all the parts of the tower can be manufactured by use of low-tech manufacturing means.

Connecting the plates by means of fish joints also enables the possibility of connecting the tower plates by means of mechanical connection means such as screws, bolts or rivets. Hereby welding in the tower is avoided, and especially in areas of the world where the time rate of wages is relatively low, it is economical advantageous to e.g. bolt the plates together, in that even though it might sometime be more time consuming than making welded joints, the bolted tower can be made of thinner plate, hereby reducing the material cost of the tower.

Furthermore, connecting the tower plates by means of fish joints is advantageous, in that especially compared to welding, the fish joints enables that the tower or sections of the tower are assembled at or close to the erection site. This is advantageous, in that the tower design is no longer limited by what can pass under bridges etc. during transport. It would be difficult and potentially be very harmful to the environment if a tower where to be welded at the erection site. First of all the welding process demands a relatively controlled environment to be preformed well and reliably, which can be difficult to achieve at an often very remote erection site. Secondly a welded joint has to be both grinded and painted afterwards, which has to be done in a controlled environment to reach a satisfactory result. Both grinding and painting are manufacturing processes, which constitutes a treat to the environment if the processes are not done in a controlled environment.

Furthermore, making the tower plates of steel is advantageous, in that steel is a well-proven, relatively inexpensive and strong material, which is very suitable for making large wind turbine towers. Additionally, machine shops for machining even relatively large steel plates (cutting, drilling, milling and bending) are found all over the world, making it possible to manufacture the tower plates relatively close to the erection site, no matter how remote this site is on the globe. The reason for this is further, that by making the tower or the tower sections of a number of tower plates it is possible to manufacture the plates in a manufacturing facility with less free height, than the full tower diameter and the plates are smaller and lighter than a full tower ring or section and thereby easier to manage during manufacturing.

It should be emphasised that by the term “Fish joint” is to be understood, a joint connecting the tower plates by means of one or more strain transferring rods, plates, fishplates, fittings or the like indirectly connecting the tower plates. The term “Fish joint” does not include joints where the tower plates are attached directly to each other e.g. by making the plates overlap and bolting them together in the overlap region.

Furthermore it should be emphasised that the term “Fish joint” is not limited to be understood only as joints where a strain transferring rod, plate, fishplate, fitting or the like is placed on the inside surface of the joint between the tower plates and another strain transferring rod, plate, fishplate, fitting or the like is placed on the outside surface of the same joint.

A “Fish joint” can also be a strain transferring rod, plate, fishplate, fitting or the like placed only on the inside surface or only on the outside surface of the joint—for connecting the tower plates.

In an aspect of the invention, said one or more fish joints comprise one or more fishplates abutting only the inside surfaces of said at least two adjacent metal tower plates and/or one or more fishplates abutting only the outside surfaces of said at least two adjacent metal tower plates.

Using fishplates is a simple and cost-efficient way of making a fish joint, and placing the fishplates either on the outside surface or the inside surface or a fishplate on both surface sides of the tower is advantageous, in that the assembly process is simplified, and the transfer of loads through a fish joint made by fishplates, becomes evenly distributed making the tower strength relatively easy to calculate. This is it advantageous, in that when the tower strength is relatively easy to calculate the cost of resizing the tower also is reduced, hereby increasing the flexibility of the tower design.

Furthermore, assembling the tower by use of fishplates enables that individual tower plates can be replaced e.g. if a tower plate was damaged by a load being hoisted to the nacelle.

In an aspect of the invention, said one or more fishplates abuts only the inside surface of said least two adjacent metal tower plates.

Placing the fishplates on the inside or the tower is advantageous in that, by “hiding” the fishplates, the tower becomes more pleasing to the eye. Furthermore the fishplates are more protected from rain, snow, saltwater and the like, when placed inside the tower.

In an aspect of the invention, said one or more fishplates are connected to said at least two adjacent metal tower plates by means of bolts.

To connect a load carrying joint in a wind turbine tower by means of welding is a rather complex procedure, which properly has to be preformed by certified welders and possibly controlled afterwards by means of x-ray, ultrasonic or another non-destructive control method, to ensure the quality of the joint. A person providing bolts to a bolted load carrying joint of a wind turbine tower only needs very little instruction to perform the job satisfactory, and the control procedure is much simpler and demands much simpler equipment.

Furthermore the connection could also be made by screws or rivets, but screws are usually more expensive than bolts and traditional rivets are most often too time-consuming to mount.

In an aspect of the invention, said one or more fishplates has a substantially rectangular shape with a substantially constant length, width and thickness.

Providing the fishplates with a simple rectangular design is advantageous, in that the manufacturing costs can be reduced and in that it is simple to calculate the load transferring abilities of simple rectangular plates with constant cross sections. This makes it easier to dimension the fishplates and the tower, which again makes this design cost efficient and flexible.

It should be emphasised that by the term “constant length, width and thickness” is to be understood that the individual fishplates each has a substantially constant length, width and thickness. The phrase does not mean that all the fishplates in a tower are limited to having the same length, width and thickness.

In an aspect of the invention, said one or more fishplates has a thickness (T) of between 1 and 50 mm, preferably between 3 and 30 mm, and most preferred between 5 and 10 mm.

If the fishplates are too thin they will not be able to transfer the necessary load and if they are too thick they become too expensive to manufacture and too heavy.

The present thickness ranges therefore provides for an advantageous relation between the fishplates functionality and cost.

In an aspect of the invention, said at least two adjacent metal tower plates comprise a first vertical or substantially vertical side region and a second vertical or substantially vertical side region, and wherein said first side region of a first tower plate of said at least two adjacent metal tower plates is connected to said second region of a further tower plate of said at least two adjacent metal tower plates.

It is advantageous to connect the tower plates through their side regions in that, load-distribution-wise it provides for an advantageous place for connecting the tower plates by mechanical connection means such as bolts, screws or rivets.

Furthermore, by making the tower or tower sections of a number of vertically connected tower plates it is possible to transport the tower as individual plates, which are assembled at or in close proximity of the erection site. Hereby it is possible to design towers with better load transferring qualities, such as a tower which is e.g. more than 10 meters in diameter at the base of the tower.

It should be emphasised that the term “vertical” is to be understood as the vertical direction on an erect wind turbine tower, as the tower would be positioned during normal use of a wind turbine.

In an aspect of the invention, said tower comprises at least two full 360° tower sections, said at least two tower sections comprising at least two horizontally adjacent metal tower plates.

Building a wind turbine tower from the foundation an upward or assembling the full tower horizontally and then erecting the entire tower at once is very difficult, particularly as the towers become bigger and bigger. It is therefore advantageous, that the tower is subdivided into sections, in that it hereby is possible to assemble a manageable portion of the tower and places it on top of at least one other tower section e.g. by means of a mobile crane with a realistic lifting capacity.

It should be emphasised that the term “horizontally” is to be understood as the horizontal direction on an erect wind turbine tower, as the tower would be positioned during normal use of a wind turbine.

In an aspect of the invention, said tower plates in a tower section are substantially identical in shape.

Making all the tower plates of a specific tower section substantially identical in shape is advantageous, in that, it simplifies the manufacturing and assembly process.

In an aspect of the invention, said tower plates in a tower section are vertically aligned.

Aligning all the tower plates in a specific tower section vertically is advantageous, in that the vertical ends of the tower plates becomes aligned, enabling a simple joint between the tower sections.

Furthermore, aligning the tower plates also provides for a more symmetrical tower, which is both more simple to assemble and more pleasing to the eye.

In an aspect of the invention, said at least two tower sections comprise between 1 and 50, preferably 2 and 30 and most preferred between 3 and 10, such as 4, 6 or 8 horizontally adjacent tower plates.

The manufacturing and assembly cost increases with the number of tower plates in a tower ring, in that more plates has to be handled and more joints has to be made. But if the number of plates becomes too low, the plates have to be so wide that they become too expensive and they become difficult to handle.

The present plate number ranges therefore provides for an advantageous relation regarding manufacturing and assembly cost.

In an aspect of the invention, at least two of said at least two full 360° tower sections comprise dissimilar numbers of tower plates.

Making the tower sections comprise different numbers of tower plates is advantageous, in that it enables a tower design where the number of vertical joints are reduced, making the assembly of the tower more efficient and fast.

In an aspect of the invention, said wind turbine tower taper upwards.

Making the tower wider at the bottom than at the top is advantageous in that, it provides for an advantageous tower design regarding transferring of loads.

It should be emphasised that the term “upwards” is to be understood as the vertical direction up on an erect wind turbine tower, as the tower would be positioned during normal use of a wind turbine.

In an aspect of the invention, said wind turbine tower is polygonal shaped.

By making the tower polygonal, expensive and complex rolling equipment is avoided, in that the tower can be made of straight and flat plates or the plates can be shaped by means of a number of vertical or substantially vertical bends. Hereby the shaping of the tower plates are not restricted to plants comprising highly specialised rolling mills, but the plates can be made on much more simple and common bending machines found all over the world. This enables the manufacturing of the towers near their mounting site, even though these areas often are rather remote, and hereby transporting the towers over long distances is avoided.

In an aspect of the invention, said at least two tower plates comprise between 1 and 15, preferably 2 or 7 vertically or substantially vertically bends.

The manufacturing costs increases with the number of bends, but regarding load distribution the optimal tower design is round, e.g. in that the tower has to transfer the moment of wind loads from all directions.

The present bend number ranges therefore provides for an advantageous relation between manufacturing cost and advantageous load transferring qualities.

In an aspect of the invention, said at least two tower plates has a bottom width, which are wider than the width of the top width.

Making the tower plates wider at the bottom than at the top is advantageous, in that it provides for a simple way of making the tower wider at the bottom than at the top, which provides for an advantageous tower design load-transferring wise.

In an aspect of the invention, said at least two tower plates has a longitudinal extend of between 1 and 50 m, preferably between 3 and 30 m, and most preferred between 7 and 15 m.

If the tower plates become too long they become difficult to handle and transport, and it becomes more difficult to find manufacturing equipment such as bending machines, flame or laser cutters and other that can handle long plates. If the plates are too short the number of plates to make a tower is increased hereby increasing the number of horizontal joints, which then would increase the time it takes to assemble a tower.

The present length ranges therefore provides for an advantageous relation between what is possible and economical advantageous to manufacture and handle and the towers assembly time.

It should be emphasised, that by the term “longitudinal extend” is to be understood, the direction in which the tower plates are the longest, which means the vertical or substantially vertical direction of the tower plates, when mounted on an erect wind turbine tower.

In an aspect of the invention, each of said at least two tower plates has a constant thickness.

Making the tower plates of plates with constant thickness is advantageous, in that it reduces the material cost and it provides for a simple manufacturing process.

It should be emphasised this does not limit all the plate to having the same thickness. It is highly feasible that it would be advantageous to make the tower plates at the bottom of the tower of plate thicker, that the plates at the top of the tower, in that the tower plates at the bottom has to transfer a much greater load, than the plates at the top of the tower.

In an aspect of the invention, said at least two tower plates has a thickness of between 1 and 50 mm, preferably between 3 and 30 mm, and most preferred between 9 and 20 mm.

If the plates become too thick, they become difficult to manufacture and the material costs would be increased. If the plates are too thin, the diameter of the tower would have to be increased accordingly to be able to transfer the same load, making the tower disadvantageously wide and increasing the number of vertical joints and thereby the assembly time.

The present thickness ranges therefore provides for an advantageous relation between manufacturing and material costs and an advantageous tower design especially regarding assembly time.

In an aspect of the invention, said at least two tower plates has a widest width of between 0.5 and 20 m, preferably between 1 and 10 m, and most preferred between 1.5 and 5 m.

If the tower plates become too wide, they become difficult to handle and transport, and it becomes more difficult to find rolling mills capable of making the wide plates. If the plates are too narrow the number of plates to make a tower is increased, hereby increasing the number of vertical joints, which then would increase the time it takes to assemble a tower.

The present width ranges therefore provides for an advantageous relation between what is possible and economical advantageous to manufacturing and handle, and the towers assembly time.

The invention further relates to a wind turbine comprising a wind turbine tower according to any of the claims 1 to 20.

Even further the invention relates to a method for assembling a wind turbine tower. The method comprises the steps of
establishing at least two tower sections by connecting at least two adjacent metal tower plates by means of one or more fish joints,
mounting a first tower section of the at least two tower sections on at least a further tower section of the at least two tower sections, and
connecting the first tower section and the further tower section.

It is advantageous to make the tower sections of at least two adjacent tower plates connected by fish joints, in that when the tower can be divided vertically it is possible to transport the individual tower plates relatively easily e.g. in standard ISO containers, to the erection site and then assemble the tower sections at the erection site e.g. by means of mechanical connection means such as screws, bolts or rivets.

Furthermore, the position of a vertical fish joint in a tower section, is not dependent on the position of vertical fish joints in other tower sections. Hence, the number of tower plates does not have to be the same in all the tower sections. This is advantageous, in that if the tower taper (as almost all wind turbine towers do) and it is economically advantageous to use tower plates of a given maximum width, such as e.g. 2.4 meters, the number of tower plates in the tower sections can be reduced through-up the tower, hereby reducing the number of vertical joints in the tower. When the number of vertical joints can be reduced, the number of e.g. bolted joints can be reduced accordingly, hereby reducing the time to assemble the tower significantly.

In an aspect of the invention, said first tower section and said further tower section are connected by means of one or more fish joints.

By also attaching the tower sections to each other by means of fish joints, all or almost all welding in or on the tower can be avoided, making it possible to reduce the materials consumption of the tower.

In an aspect of the invention, said at least two tower sections are made to form full 360° rings.

Making the tower sections as full 360° rings is advantageous, in that the towers strength and rigidity is hereby increased, particularly because the tower has to withstand wind loads from all directions.

It should be emphasised that the term “full 360° rings” does not limit the tower sections to having a specific shape, such as circular. The tower sections could also have a triangular, square, rectangular, elliptical, polygonal or other shape in a horizontal cross-section. The term “full 360° rings” only means that the shape is closed.

In an aspect of the invention, said one or more fish joints are made by making one or more fishplates abut only the inside surfaces of said least two adjacent metal tower plates and/or made by making one or more fishplates abut only the outside surfaces of said at least two adjacent metal tower plates.

In an aspect of the invention, said one or more fishplates abuts only the inside surface of said least two adjacent metal tower plates.

In an aspect of the invention, said one or more fishplates are connected to said at least two adjacent metal tower plates by means of bolts.

In an aspect of the invention, said one or more fishplates has a substantially rectangular shape with a substantially constant length, width and thickness.

In an aspect of the invention, said at least two adjacent metal tower plates comprise a first vertical or substantially vertical side region and a second vertical or substantially vertical side region, and wherein said first side region of a first tower plate of said at least two adjacent metal tower plates is connected to said second region of a further tower plate of said at least two adjacent metal tower plates.

In an aspect of the invention, said tower plates in a tower section are substantially identical in shape.

In an aspect of the invention, said tower plates in a tower section are vertically aligned.

In an aspect of the invention, said at least two tower plates are provided with between 1 and 15, preferably 2 or 7 vertically or substantially vertically bends.

In an aspect of the invention, said assembling is done at or in close proximity of the mounting site where said wind turbine tower is to be erected.

Assembling the tower at or in close proximity of the site where the tower is to be erected is advantageous, in that transport over long distances, of large tower parts which are difficult to manage, is avoided. Furthermore, assembling the tower at or in close proximity of the erection site is possible due to the fact, that a bolted load carrying joint can be made correctly even under relatively primitive conditions, whereas a welded load carrying joint demands a more controlled environment to be made reliably.

### BRIEF DESCRIPTION OF THE DRAWINGS

The invention will be described in the following with reference to the figures in which

FIG. 1 illustrates a large modern wind turbine known in the art, as seen from the front,

FIG. 2 illustrates a tower section of a wind turbine tower according to the invention—as seen from the top,

FIG. 3 illustrates a wind turbine tower according to the invention as seen from the front,

FIG. 4 illustrates a tower plate as seen from the back i.e. from the inside of a wind turbine tower,

FIG. 5 illustrates the same tower plate as illustrated in FIG. 4, as seen from the top,

FIG. 6 illustrates a cross section of an embodiment of a fish joint between two tower plates, as seen from the top,

FIG. 7 illustrates a cross section of an embodiment of a fish joint between two tower plates of different thicknesses, as seen from the top,

FIG. 8 illustrates a part of the inside of a wind turbine tower comprising fish joints, as seen from the back, and

FIG. 9 illustrates a part of a vertical cross section through a horizontal fish joint at the top of a wind turbine tower, as seen from the front.

### DETAILED DESCRIPTION OF THE INVENTION

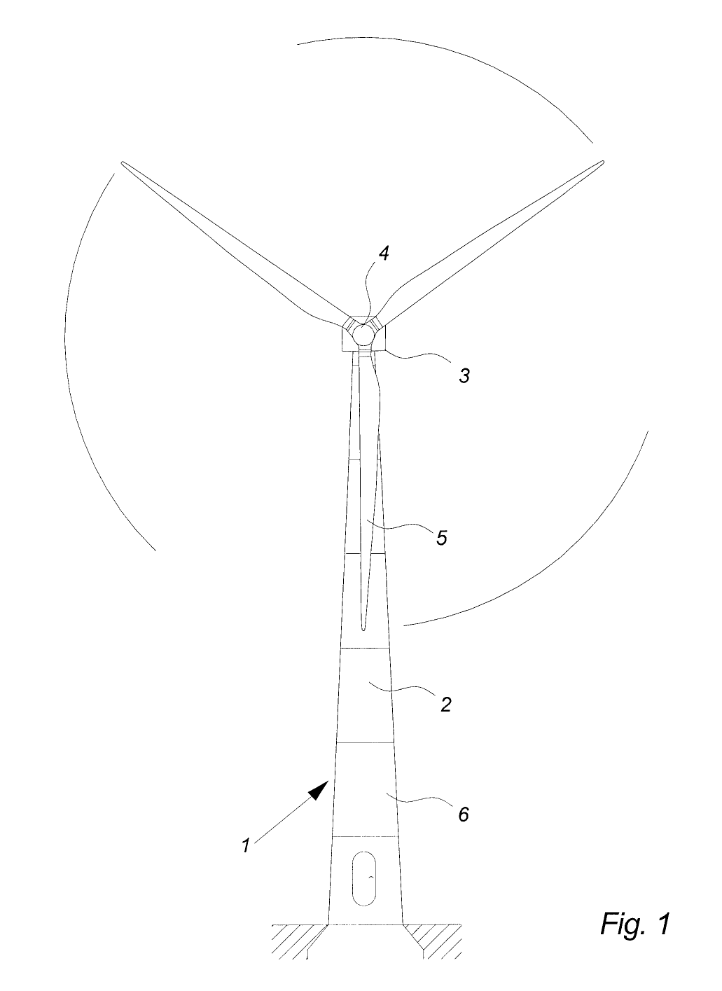

FIG. 1 illustrates a wind turbine 1 known in the art, comprising a tapered tower 2, which is subdivided into a number of tower sections 6. A wind turbine nacelle 3 is positioned on top of the tower 2.

The wind turbine rotor 4, comprising a number of wind turbine blades 5, is connected to the nacelle 3 through the low speed shaft which extends out of the nacelle 3 front.

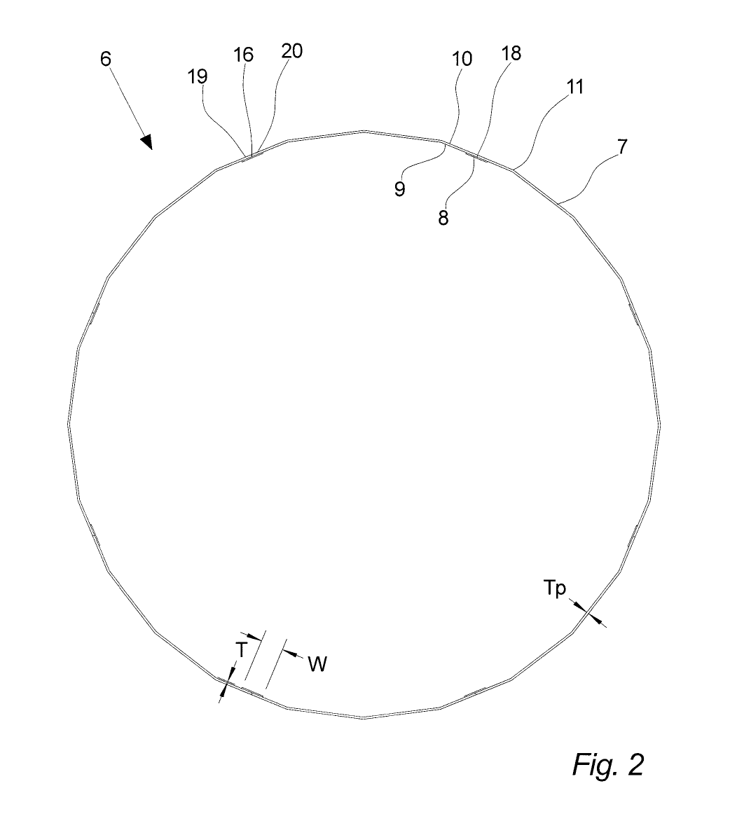

FIG. 2 illustrates a section 6 of a wind turbine tower 2 according to the invention as seen from the top. In this embodiment of the invention the tower section 6 comprise eight tower plates 7 placed side by side. In another embodiment of the invention the tower section 6 could comprise another number of tower plates 7 such as two, four, six or ten. None of the plates 7 or parts of the plates 7 overlaps other plates 7 or parts of other plates 7.

Adjacent tower plates 7 create a number of vertical or substantially vertical joints 18 which are connected by fish joints 16, which by means of fishplates 8 attached to the adjacent plates 7 on their inside surfaces 9 connects the plates 7. In another embodiment of the invention the fishplates 8 could also be provided on the outside surface 10 of the tower plates 7, alternately on the inside surface 9 and the outside surface 10, the plates 7 could be provided with fishplates 8 both on the inside surface 9 and the outside surface 10 or the fishplates 8 could be placed in another way, as long as a given fishplate 8 always is attached to the same surface side 9, 10 of both of plates 7 it connects.

In this embodiment of the invention the eight tower plates 7 are identical or substantially identical and each of the tower plates 7 comprise three vertical bends 11, giving the tower section 6 a twenty four sided polygonal shape. In another embodiment of the invention each of the tower plates could comprise another number of vertical bends 11 such as one, two, four or five. The eight plates 7 could also comprise varying number of bends 11, the eight plates 7 could be completely straight and flat plates 7 making the tower section 6 eight sided or the plates 7 could be rolled making the tower section 6 round, where each of the eight plates 7 would constitute substantially 45° of the full 360° tower section 6 or the tower section 6 could comprise a combination of differently shaped plates 7.

If the tower section 6 was made of e.g. eight straight plates 7, the fishplates 8 could comprise a vertical bend e.g. through the middle, to make substantially the entire side of the fishplates 8 facing the tower plates 7, abut the inside surface 9 of the tower plates 7. Likewise, if the tower plates 7 were rolled, the fishplates 8 could also be rolled to fit the shape of the tower plates 7 around the joints 15, 18.

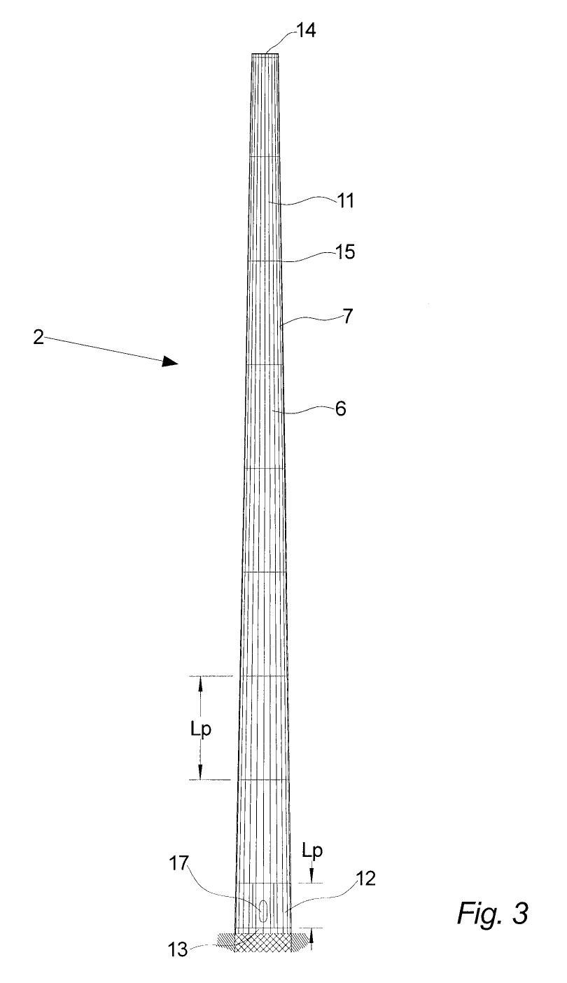

FIG. 3 illustrates a wind turbine tower 2 according to the invention as seen from the front. In this embodiment of the invention the tower 2 comprises nine tower sections 6, but in another embodiment the tower 2 could comprise another number of sections 6. The bottom tower section 12 is in this embodiment 3820 mm high Lp and the other eight tower sections 6 are all 9000 mm high Lp making the tower a total of 75820 mm high, but these heights Lp both of the individual tower sections 6, 12 and the total tower height can of course be varied almost infinitely within the scope of the invention.

In this embodiment of the invention the bottom tower section 12 is not as high Lp as the rest of the sections 6, because the bottom tower section 12 comprises a tower plate 7 with a door aperture 17. The plate 7 with the door aperture 17 is considerably thicker Tp than the rest of the tower plates 7 in the bottom section 12, and to reduce the use of material, the bottom section 12 is in this embodiment of the invention made shorter than the rest of the sections 12. In another embodiment of the invention the plate 7 comprising the door aperture 17 could be placed in another section 6 of the tower 2, such as the second or the third section 6 counted from the bottom 13 of the tower 2 or the door aperture 17 could be made in another way making it possible and/or advantageous to make the section 6 comprising the door aperture 17 of a different height Lp. Providing the door aperture 17 in the second or third section 6 could be advantageous e.g. off-shore, where the door would be placed in safe or relatively safe distance from waves and water in other ways splashing against the tower 2. Such a relatively high door position would off cause demand access means e.g. in form of ladders, stairs, lifts or other placed on the outside of the tower 2.

In this embodiment of the invention the thickness Tp of the tower plates 7 vary through up the tower 2. In this embodiment all the tower plates 7 in the bottom section 12 (except the plate 7 comprising the door aperture 17, which is 27 mm thick) and the section 6 placed directly above it, are all 17 mm thick. The plates 7 in third and fourth section 6 is all 16 mm thick, the plates 7 in the fifth section 6 are all 15 mm thick, the plates 7 in the sixth section 6 are all 14 mm thick, the plates 7 in the seventh section 6 are all 13 mm thick and the plates 7 in the ninth and upper section 6 are all 12 mm thick, where all the sections 6 are counted from the bottom 13 of the tower 2 and upwards. This variation in the plate thickness Tp through up the tower 2, is done to reduce the use of material in the tower 2 and thereby reduce the towers 2 cost, in that the strain which the tower 2, the tower sections 6 and the tower plates 7 has to withstand is reduced upwards. In another embodiment of the invention the thickness Tp of the tower plates 7 could vary between 1 and 50 mm, preferably between 4 and 35 mm and most preferred between 8 and 25 mm.

The tower plates 7 could also be placed staggered, where the tower plates 7 at the bottom 13 and/or the top 14 of the tower 2 alternately would have different length Lp. All the other plates 7 in the tower 2 could then have substantially identical length Lp. This staggered construction would result in that no horizontal joints 15 between the tower plates 7 would be placed directly next to each other. A variation of this tower 2 design would be to make a number of tower sections 6 of staggered tower plates 7.

In this embodiment of the invention the tower taper in a substantially constant angle because all the tower sections 6 taper in a substantially constant angle, making the tower 2 wider at the bottom 13 than at the top 14, but in another embodiment the tower 2 could have a constant cross-section making the tower 2 straight, the tower 2 could comprise curves such as convex or concave curves e.g. making the tower 2 trumpet shaped, the towers 2 diameter could be reduced upwards in steps or the tower 2 could be designed otherwise depending on the erection site, the size of the tower 2, production costs, transportation or other.

A tower 2—as illustrated in FIG. 3—made from tower plates 7 connected by means of bolted fishplates 8, can contain over 15,000 bolts 22. Both during the assembly of the tower, immediately after and at certain intervals during the towers 2 life the bolts 22 of the joints 15, 18 has to be controlled and possibly tightened up. An elevator, which easily can be positioned in front of or in close proximity of these bolts 22, no matter their “radial” or “axial” position in the tower 2 could therefore advantageously be provide to the inside of the tower 2.

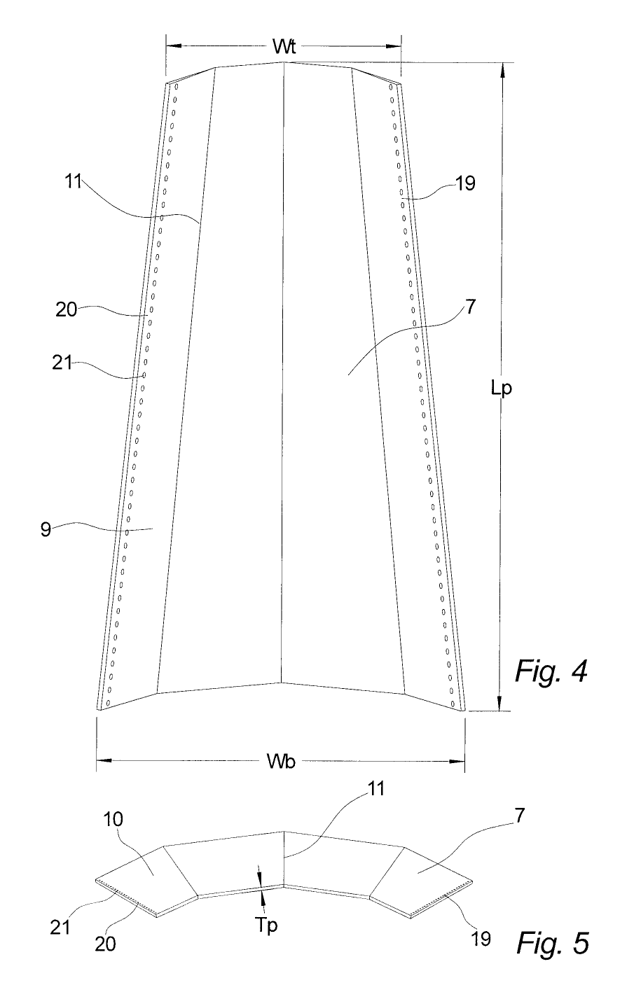

FIG. 4 illustrates a tower plate 7 as seen from the back i.e. from the inside of a wind turbine tower 2, and FIG. 5 illustrates the same tower plate 7 as seen from the top. This embodiment of a tower plate 7 comprises three vertical or substantially vertical bends 11 and the tower plate 7 has a bottom width Wb, which is wider than the top width Wt to enable, that the tower 2 taper in an substantially constant angle, but in another embodiment the tower plate 7 could also be substantially rectangular or the vertical or substantially vertical side regions 19, 20 could be non-linear e.g. curving outward at the bottom.

In this embodiment of the invention the side regions 19, comprise a number of round through-holes 21 for making a fish joint 16, by attaching one or more fishplates 8 to the tower plate 7 by use of bolts 22, screws, rivets or other connection means through the holes 21 in the tower plate 7 and corresponding holes 23 in the fishplates 8. In another embodiment the holes 21 could also be treaded trough-holes or treaded blind-holes.

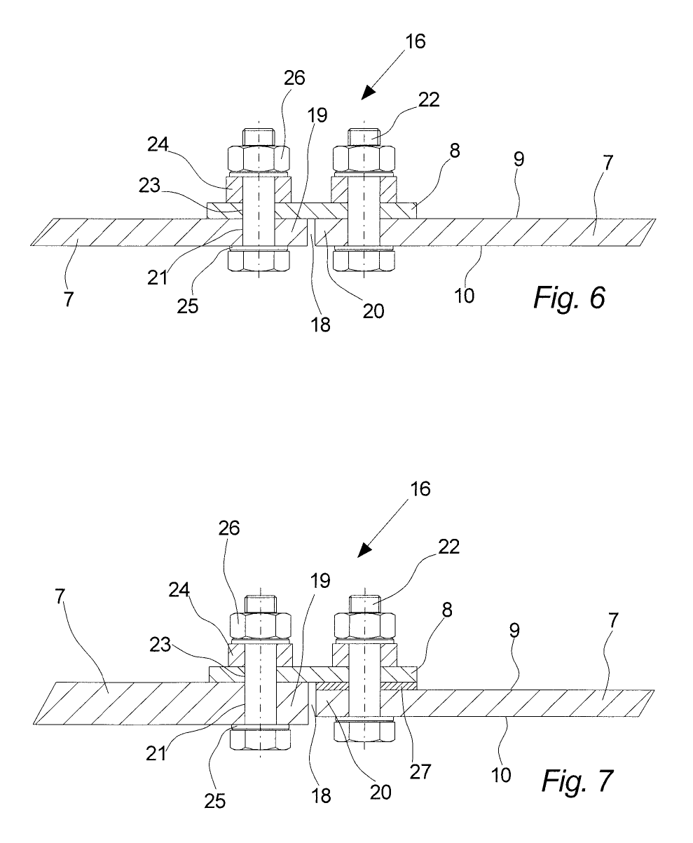

FIG. 6 illustrates a cross section of an embodiment of a fish joint 16 between two tower plates 7 as seen from the top. In this embodiment of the invention a fishplate 8 is provided on the inside surface 9 of the two tower plates 7. In another embodiment the fishplate 8 could also be placed on the outside surface 10 of the two plates 7 or fishplates 8 could be placed on both the inside 9 and the outside surface 10 of the tower plates 7.

In this embodiment of the invention the vertical joint 18 between the tower plates 7 comprise only two rows of bolts 22—one row through a first vertical side region 19 of a first tower plate 7 and another row through a second vertical side region 20 of a further tower plate 7. But in another embodiment of the invention the fishplate 8 could be attached by another number of bolt 22 rows, such as two or three rows of bolts 22 through each of the plates 7 side regions 19, 20.

In another embodiment the joint 18 could be provide with a fishplate 8 on both the inside 9 and the outside 10 of the joint 18, where the distance between the tower plates 7 was so big, that a relatively large diameter bolt 22 could pass between. The fish joint 16 could then be made by the fishplates squeezing against the inside 9 and outside surfaces 10 of the tower plates 7. Holes 21 in the tower plates 7 would then be avoided and the joint 16 could be made e.g. by only one row of bolts 22 though the middle of the fishplates, clamping the two tower plates and thereby fixating them.

In this embodiment of the invention the holes 21, 23 in both the fishplate 8 and the tower plates 7 are made during the manufacturing of the parts 7, 8, but in another embodiment of the invention e.g. only the holes in the fishplate 23 could be made in advance. The holes in the tower plates 21 could then be made during the assembling of the tower 2, e.g. by using the fishplate 8 as a template or jig when making the holes in the tower plates 21 or only the holes in the tower plates 21 could be made in advance, where the holes in the fishplates 23 would be made during the assembly. This procedure could e.g. be advantageous if a tight fit of the bolts 22 or rivets was desired e.g. to ensure a very rigid and internally stabile tower 2.

In this embodiment of the invention the fishplate 8 is attached to the tower plates 7 by means of bolts 22 put through holes 21 in the tower plates 7 and holes 23 in the fishplate 8 and secured by means of nuts 26 on the inside of the tower 2. A bush 24 ensures that the free length of the bolt is long enough, for the bolt to be tightened sufficiently and to maintain this pre-tension e.g. even if the plates vibrate.

The tower plates 7 are in this embodiment spaced slightly apart by e.g. 5 mm to compensate for any linear expansion of the parts 7, 8. Furthermore, washers 25 are provided between the nuts 26 and the bushes 24 and between the head of the bolt 22 and the tower plates 7.

To prevent the bolts 22 from rotating when the nuts 26 are tightened on the inside of the tower 2, the bolts 22 could be provided with lock washers on the outside of the tower 2 or the bolts 22 could be provided with a hexagonal socket in the end of the bolt 22 (on the inside of the tower 2), for retaining the bolt 22 during the tightening of the nut 26. This enables that all tightening of the bolts 22 can be done entirely from the inside of the tower 2.

FIG. 7 illustrates a cross section of an embodiment of a fish joint 16 between two tower plates 7 of different thicknesses Tp, as seen from the top.

As previously explained the tower plate 7 comprising the door aperture 17 can be made of a plate thicker than the rest of the tower plates 7 to compensate for the loss of strength caused by the hole 17. FIG. 7 shows an example of how a vertical 18 or horizontal joint 15 could be made, when the adjacent tower plates 7 are of different thickness Tp. If—as illustrated—it is desired that the centre of the plates 7 are aligned, an adjusting washer 27 can be provided between the fishplate 8 and the thinnest of the two tower plates 7. In this embodiment of the invention the adjusting washer 27 is formed as a normal washer with a relatively large thickness, but in another embodiment the adjusting washer 27 could also be formed as an elongated plate such as a fishplate comprising two or more holes, making a single plate act as an adjusting washer 27 at two or more holes in the tower plates 7 an fishplates 8.

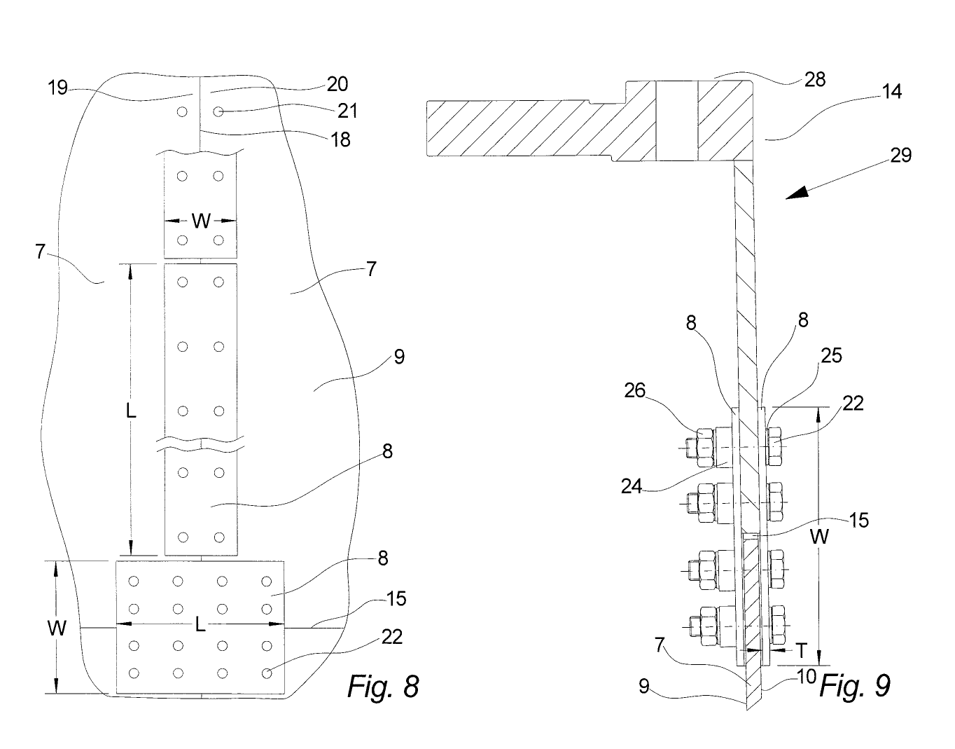

FIG. 8 illustrates a part of the inside of a wind turbine tower 2 comprising fish joints 16 as seen from the back i.e. the inside of the tower 2. In this embodiment of the invention the fishplates 8 are spaced slightly apart e.g. by 5 mm free space—to compensate for any linear expansion.

The fishplates 8 could be of varying thickness T depending on their location in or on the tower 2, which would mean that all the fishplates 8 would be made to be placed in a specific location in or on the tower 2. Or the fishplates 8 provided for making the vertical fish joints 18 could be substantially of the same width W and thickness T throughout the entire tower 2. This enables the possibility of prefabricating and pre-painting the fishplates 8 in fixed lengths and then cutting them up in desired length L at the erection site. Only the ends where the cuts where made would then have to be painted at the site, which possibly could be done by hand using a paintbrush.

Alternatively all the fishplates 8 could be made in a length L of e.g. one meter, where only one of these relatively short fishplates 8 would have to be cut and repainted to fit the length of specific section 6. The fishplates 8 could also be made by combining the different methods described above.

The fishplates 8 illustrated in FIGS. 2, 6, 7, 8 and 9 are characterized by being relative long L and thin T compared to their width W, but in another embodiment of the invention the device provided to enable a fish joint 16 could also be a plate, which is characterized in that its length L is only up to twice the width W, it could be a rod or a bar, which is characterized in that its width W and thickness T is substantially the same or in that the bar or rod is relatively thick T compared to its width W or it could be some kind of special designed fitting provided to solve the task of connecting two tower plates 7 in a wind turbine tower 2 via a fish joint 16.

FIG. 9 illustrates a part of a vertical cross section through a horizontal fish joint 16 at the top 14 of a wind turbine tower 2. The nacelle 3 has to be connected to the top of the tower 2 most often through a yaw mechanism. To enable this connection the tower 2 has to be provided with a horizontal flange 28. This can e.g. be done as illustrated in FIG. 9 by making the top of the tower 14 as a very short tower section 29. This short top tower section 29 could be made as one fully welded part, which would be annealed and painted in a controlled environment and then transported to the erection site as one part. If the tower 2 taper, the short top tower section 29 will have a relative small “diameter” and given its little length, even a top section 29 for a relatively large wind turbine 1 would easily be transported without causing problems when passing bridges, tunnels etc.

The invention has been exemplified above with reference to specific examples of fish joints 16, fishplates 8 and tower plates 7 for use in wind turbine towers 2. However, it should be understood that the invention is not limited to the particular examples described above but may be designed and altered in a multitude of varieties within the scope of the invention as specified in the claims.

### LIST

1. Wind turbine
2. Tower
3. Nacelle
4. Rotor
5. Blade
6. Tower section
7. Tower plate
8. Fishplate
9. Inside surface of tower plate
10. Outside surface of tower plate
11. Vertical bend
12. Bottom tower section
13. Bottom of tower
14. Top of tower
15. Horizontal joint
16. Fish joint
17. Door aperture
18. Vertical joint
19. First vertical side region of tower plate
20. Second vertical side region of tower plate
21. Hole in tower plate
22. Bolt
23. Hole in fishplate
24. Bush
25. Washer
26. Nut
27. Adjusting washer
28. Horizontal flange
29. Top tower section
L. Length of device for enabling a fish joint
T. Thickness of device for enabling a fish joint
W. Width of device for enabling a fish joint
Lp. Length of tower plate
Tp. Thickness of tower plate
Wb. Bottom width of tower plate
Wt. Top width of tower plate

1. A wind turbine tower comprising
at least two adjacent metal tower plates
characterized in that
said tower plates are connected by one or more fish joints.

2. The wind turbine tower according to claim 1, wherein said one or more fish joints comprise one or more fishplates abutting only the inside surfaces of said least two adjacent metal tower plates and/or one or more fishplates abutting only the outside surfaces of said at least two adjacent metal tower plates.

3. The wind turbine tower according to claim 2, wherein said one or more fishplates abuts only the inside surface of said at least two adjacent metal tower plates.

4. The wind turbine tower according to claim 2, wherein said one or more fishplates are connected to said at least two adjacent metal tower plates by means of bolts.

5. The wind turbine tower according to claim 2, wherein said one or more fishplates has a substantially rectangular shape with a substantially constant length (L), width (W) and thickness (T).

6. The wind turbine tower according to claim 2, wherein said one or more fishplates has a thickness (T) of between 1 and 50 mm, preferably between 3 and 30 mm, and most preferred between 5 and 10 mm.

7. The wind turbine tower according to claim 1, wherein said at least two adjacent metal tower plates comprise a first vertical or substantially vertical side region and a second vertical or substantially vertical side region, and wherein said first side region of a first tower plate of said at least two adjacent metal tower plates is connected to said second region of a further tower plate of said at least two adjacent metal tower plates.

8. The wind turbine tower according to claim 1, wherein said tower comprises at least two full 360° tower sections, said at least two tower sections comprising at least two horizontally adjacent metal tower plates.

9. The wind turbine tower according to claim 8, wherein said tower plates in a tower section are substantially identical in shape.

10. The wind turbine tower according to claim 8, wherein said tower plates in a tower section are vertically aligned.

11. The wind turbine tower according to claim 8, wherein said at least two tower sections comprise between 1 and 50, preferably 2 and 30 and most preferred between 3 and 10, such as 4, 6 or 8 horizontally adjacent tower plates.

12. The wind turbine tower according to claim 8, wherein at least two of said at least two full 360° tower sections comprise dissimilar numbers of tower plates.

13. The wind turbine tower according to claim 1, wherein said wind turbine tower taper upwards.

14. The wind turbine tower according to claim 1, wherein said wind turbine tower is polygonal shaped.

15. The wind turbine tower according to claim 1, wherein said at least two tower plates comprise between 1 and 15, preferably 2 or 7 vertically or substantially vertically bends.

16. The wind turbine tower according to claim 1, wherein said at least two tower plates has a bottom width (Wb) which are wider than the width of the top width (Wt).

17. The wind turbine tower according to claim 1, wherein said at least two tower plates has a longitudinal extend (Lp) of between 1 and 50 m, preferably between 3 and 30 m, and most preferred between 7 and 15 m.

18. The wind turbine tower according to claim 1, wherein each of said at least two tower plates has a constant thickness (Tp).

19. The wind turbine tower according to claim 1, wherein said at least two tower plates has a thickness (Tp) of between 1 and 50 mm, preferably between 3 and 30 mm, and most preferred between 9 and 20 mm.

20. The wind turbine tower according to claim 1, wherein said at least two tower plates has a widest width (Wb) of between 0.5 and 20 m, preferably between 1 and 10 m, and most preferred between 1.5 and 5 m.

21. The wind turbine according to claim 1, whereby said wind turbine tower is assembled as part of a wind turbine.

22. A method for assembling a wind turbine tower, said method comprising the steps of
establishing at least two tower sections by connecting at least two adjacent metal tower plates by means of one or more fish joints,
mounting a first tower section of said at least two tower sections on at least a further tower section of said at least two tower sections, and
connecting said first tower section and said further tower section.

23. The method according to claim 22, wherein said first tower section and said further tower section are connected by means of one or more fish joints.

24. The method according to claim 22, wherein said at least two tower sections are made to form full 360° rings.

25. The method according to claim 22, wherein said one or more fish joints are made by making one or more fishplates abut only the inside surfaces of said least two adjacent metal tower plates and/or made by making one or more fishplates abut only the outside surfaces of said at least two adjacent metal tower plates.

26. The method according to claim 25, wherein said one or more fishplates abuts only the inside surface of said at least two adjacent metal tower plates.

27. The method according to claim 25, wherein said one or more fishplates are connected to said at least two adjacent metal tower plates by means of bolts.

28. The method according to claim 25, wherein said one or more fishplates has a substantially rectangular shape with a substantially constant length (L), width (W) and thickness (T).

29. The method according to claim 22, wherein said at least two adjacent metal tower plates comprise a first vertical or substantially vertical side region and a second vertical or substantially vertical side region, and wherein said first side region of a first tower plate of said at least two adjacent metal tower plates is connected to said second region of a further tower plate of said at least two adjacent metal tower plates.

30. The method according to claim 22, wherein said tower plates in a tower section are substantially identical in shape.

31. The method according to claim 22, wherein said tower plates in a tower section are vertically aligned.

32. The method according to claim 22, wherein said at least two tower plates are provided with between 1 and 15, preferably 2 or 7 vertically or substantially vertically bends.

33. The method according to claim 22, wherein said assembling is done at or in close proximity of the mounting site where said wind turbine tower is to be erected.
